(19) United States
(12) Patent Application Publication
(10) Pub. No.: US 2016/0212447 A1
(43) Pub. Date: Jul. 21, 2016

(54) METHOD FOR MANAGING DECODED PICTURE BUFFER (DPB) IN A MULTI-VIEW VIDEO CODING (MVC) DECODER

(71) Applicant: SAMSUNG ELECTRONICS CO., LTD., Suwon-si (KR)

(72) Inventors: Austin LOBO, Bangalore (IN); Mohammed Quaid DAMUDI, C.V.Raman Nagar Bangalore (IN)

(73) Assignee: SAMSUNG ELECTRONICS CO., LTD., Suwon-si (KR)

(21) Appl. No.: 15/003,033

(22) Filed: Jan. 21, 2016

(30) Foreign Application Priority Data
Jan. 21, 2015 (IN) 295/CHE/2015

(51) Int. Cl. H04N 19/597

(52) U.S. Cl. CPC H04N 19/597

(57) ABSTRACT

Managing a decoded picture buffer (DPB) in a multi-view video coding (MVC) decoder is provided by detecting a trailing picture after an anchor picture in a base view, marking one or more reference pictures prior to the anchor picture as unused for reference in base view and one or more non-base views, transmitting the one or more marked reference pictures to an electronic device for post-processing, determining that the one or more reference pictures are displayed, and releasing the one or more pictures from the DPB in the base view and the one or more non-base views, once the one or more pictures are displayed and if those pictures are marked as unused for reference.

### CROSS-REFERENCE TO RELATED APPLICATION

This application claims priority from Indian Patent Application No. 295/CHE/2015, filed on Jan. 21, 2015, in the Indian Patent Office, the disclosure of which is incorporated herein by reference in its entirety.

### BACKGROUND

1. Field

Methods and apparatuses consistent with exemplary embodiments relate to multi-view video coding (MVC), and more particularly, to a method and apparatus for managing a decoded picture buffer (DPB) in an MVC decoder.

2. Description of Related Art

With recent advancements in video capture and display technologies, three-dimensional video communication and entertainment services are in high demand. With the development of video coding standards, digital video plays an important role in a host of applications, ranging from video conferencing and digital video discs (DVDs) to digital TV, mobile video, and Internet video streaming and sharing.

Methods of video coding defined by video coding standards are used to compress video data in both temporal and spatial domains using various techniques. For example, multi-view video coding (MVC) is an extension of the H.264/advanced video coding (AVC) video coding standard. In general, MVC is a compression framework for encoding multi-view sequences. A multi-view sequence is a set of two or more video sequences that have captured a same scene through multiple cameras. Each of the cameras capture the same scene from different angles (view points). Accordingly, MVC allows several video sequences having different views of a scene to be encoded in a single bitstream, which includes a base view and additional non-base views. The base view may be encoded as a base layer, and the additional non-base views may be encoded based on the base view as one or more enhancement layers. Therefore, there exists a coding dependency between the encoded base view (i.e., base layer) and the encoded non-base views (i.e., enhancement layer). After encoding, each view may be represented as an individual bitstream, or the individual bitstreams may be merged together.

In MVC, the concept of an anchor picture has been introduced. The anchor picture corresponds to the start of a group of pictures (GOP) in MVC, and the anchor picture may be defined as a coded picture in which all slices may refer to slices within a same access unit, and as such, inter-view prediction may be used, but inter prediction is not used. All subsequently coded pictures output do not use inter prediction from any picture prior to the coded picture in decoding order.

The anchor picture may also have associated leading pictures and trailing pictures. The pictures preceding the anchor picture in the display order are referred to as leading pictures. All the leading pictures have a Picture Order Count (POC) value less than the associated anchor picture. The POC value may indicate the output or display order of a picture, and may be used to identify the picture. For example, within a coded video sequence, a picture with a smaller POC value is displayed earlier than a picture with larger POC value.

There are two types of leading pictures, namely decodable leading pictures and non-decodable leading pictures. Decodable leading pictures can be correctly decoded when the decoding is started from the anchor picture. In other words, the decodable leading pictures use only the initial intra picture or the subsequent pictures in decoding order as reference pictures in inter prediction. On the other hand, non-decodable leading pictures cannot be correctly decoded when decoding is initiated from the initial intra picture starting the open GOP. In other words, non-decodable leading pictures use pictures prior, in decoding order, to the initial intra picture starting the open GOP as reference pictures in inter prediction. A trailing picture can be decoded without reference to previously decoded pictures prior to the anchor picture. All the trailing pictures have POC values greater than the POC value of the associated anchor picture.

To achieve efficient compression, the H.264 standard allows prediction from multiple reference pictures. The standard specifies that the decoded picture buffers are handled through reference picture marking and decoding picture buffer (DPB) management. MVC follows a similar reference picture marking process and DPB management. Decoded pictures used for predicting subsequent coded pictures and for future output are buffered in the DPB. To efficiently utilize the buffer memory, a DPB management process is used, which includes managing the storage of decoded pictures into the DPB, the marking process of reference pictures, and the process of output and removal of decoded pictures from the DPB.

The DPB management in the MVC standard is as described herein. At each view, after decoding a picture, a default sliding window marking process or adaptive picture marking process is applied. Each view applies marking process for its own view. In an example, after decoding the picture of a base view, marking of the base view can only mark a previously decoded reference picture as unused for reference from only base view pictures.

The method of picture marking in the existing MVC standard is explained herein with an example. Consider an open GOP MVC encoded pattern with two views, a view 0 (base view) and a view 1 (non-base view). Both the views follow identical temporal GOP structure pattern and a default sliding window marking process is used. While decoding the GOP, in case, when the trailing picture is detected after the anchor picture, the decoded reference pictures prior to the anchor picture are stored in the DPB, but the decoded reference pictures prior to the anchor picture are unnecessary for decoding the trailing picture.

A critical issue for any decoder operating according to a video coding standard is efficiency. With respect to an MVC decoder, efficiency is required in terms of resource consumption, memory size, bandwidth, and so on. However, memory size for MVC is substantially increased due to the increase of the DPB size, which is used for storing decoded pictures for prediction of subsequent pictures.

### SUMMARY

Aspects of the exemplary embodiments provide for efficiently managing a decoded picture buffer (DPB) in a multi-view video coding (MVC) decoder.

According to an aspect of an exemplary embodiment, there is provided a method of managing a decoded picture buffer (DPB) in a multi-view video coding (MVC) decoder, the method including receiving a picture sequence, the picture sequence comprising an anchor picture in a base view and a trailing picture temporally after the anchor picture in the picture sequence, detecting the trailing picture after the anchor picture in the picture sequence, and marking at least one reference picture prior to the anchor picture in the picture sequence, the at least one reference picture stored in the DPB, as unused for reference in the base view and at least one non-base view.

According to an aspect of an exemplary embodiment, there is provided a multi-view video coding (MVC) decoder for managing a decoded picture buffer (DPB), including at least one processor configured to receive a picture sequence, the picture sequence comprising an anchor picture in a base view and a trailing picture temporally after the anchor picture in the picture sequence, detect the trailing picture after the anchor picture in the picture sequence, and mark at least one reference picture prior to the anchor picture in the picture sequence, the at least one reference picture stored in the DPB, as unused for reference in the base view and at least one non-base view.

According to an aspect of an exemplary embodiment, there is provided a system for managing a decoded picture buffer (DPB) of a multi-view video coding (MVC) picture sequence, the system including an electronic device and an MVC decoder, the MVC decoder configured to receive the MVC picture sequence, the picture sequence comprising an anchor picture in a base view and a trailing picture temporally after the anchor picture in the picture sequence, detect the trailing picture after the anchor picture the picture sequence, and mark at least one reference picture prior to the anchor picture as unused for reference in the base view, the at least one reference picture stored in the DPB.

According to an aspect of an exemplary embodiment, there is provided a non-transitory computer-readable recording medium having embodied thereon a computer executable program, said computer executable program when executed causing a multi-view video coding (MVC) decoder to execute a method of managing a decoded picture buffer (DPB, the method including receiving a picture sequence, the picture sequence comprising an anchor picture in a base view and a trailing picture temporally after the anchor picture in the picture sequence, detecting the trailing picture after the anchor picture in the picture sequence, and marking at least one reference picture prior to the anchor picture in the picture sequence, the at least one reference picture stored in the DPB, as unused for reference in the base view and at least one non-base view.

### BRIEF DESCRIPTION OF THE DRAWINGS

The above and other aspects will be better appreciated and understood when considered in conjunction with the following description and the accompanying drawings. It should be understood, however, that the following descriptions, while illustrating preferred embodiments and numerous specific details thereof, are given by way of illustration and not of limitation. Many changes and modifications may be made within the scope of the embodiments herein without departing from the spirit thereof, and the embodiments herein include all such modifications.

The exemplary embodiments are illustrated with reference to the accompanying drawings, throughout which like numerals indicate same corresponding parts in the various figures. The exemplary embodiments herein will be better understood from the following description with reference to the drawings, in which:

FIG. 1 illustrates a block diagram of a system for managing a Decoded Picture Buffer (DPB) in a Multi-View video Coding (MVC) decoder, according to an exemplary embodiment;

FIG. 2 illustrates a flowchart of a method for managing the DPB in the MVC decoder, according to an exemplary embodiment;

FIG. 3 illustrates a diagram of an example in which the reference pictures prior to an anchor picture are marked in the DPB, according to an exemplary embodiment; and

FIG. 4 illustrates a computing environment implementing a method for managing the DPB in the MVC decoder, according to an exemplary embodiment.

### DETAILED DESCRIPTION OF THE EXEMPLARY EMBODIMENTS

The exemplary embodiments herein and the various features and advantageous details thereof are explained more fully with reference to the following description and the accompanying drawings. Descriptions of well-known components and processing techniques are omitted to avoid unnecessarily obscuring the description of the exemplary embodiments. Also, the exemplary embodiments described herein are not necessarily mutually exclusive, as some exemplary embodiments can be combined with one or more other exemplary embodiments to form new exemplary embodiments.

The term “or” as used herein, refers to a non-exclusive or, unless otherwise indicated.

As used herein, the term “and/or” includes any and all combinations of one or more of the associated listed items.

Expressions such as “at least one of,” when preceding a list of elements, modify the entire list of elements and do not modify the individual elements of the list.

It will be understood that the terms “comprise” and/or “comprising” when used in this specification, specify the presence of stated features, integers, steps, operations, elements, and/or components, but do not preclude the presence or addition of one or more other features, integers, steps, operations, elements, components, and/or groups thereof.

Also, the terms “unit”, “module”, etc. mean units for processing at least one function or operation and may be embodied as hardware, software, or a combination thereof.

The examples used herein are intended merely to facilitate an understanding of ways in which the exemplary embodiments may be practiced and to further enable those skilled in the art to practice the exemplary embodiments. Accordingly, the examples should not be construed as limiting the scope of the embodiments herein.

Aspects of the exemplary embodiments achieve a method for managing a decoded picture buffer (DPB) in a multi-view video coding (MVC) decoder by detecting a trailing picture after an anchor picture in a base view and marking one or more reference pictures prior to the anchor picture as unused for reference in a base view and one or more non-base views.

The method may include sending the one or more pictures marked as unused for reference in the base view and the one or more non-base views to an electronic device for post-processing.

The method may include determining the one or more pictures are available for display.

The pictures may be either reference pictures or non-reference pictures.

The method may include sending the one or more pictures to the electronic device for display in response to determining that the one or more pictures are available for display.

The method may include obtaining a message from the electronic device.

The message may indicate a status of the display of the one or more pictures by the electronic device. If the status indicates that the one or more pictures are displayed and if such pictures are marked as unused for reference, then the method may include releasing one or more of those pictures from the DPB.

The method may include releasing a collocated Motion Vector (MV) buffer associated with the one or more pictures from the DPB.

Unlike conventional coding techniques, the proposed method provides a mechanism for managing the DPB in the MVC decoder by releasing one or more pictures that are marked as unused for reference earlier than the conventional system in which the reference pictures are maintained at the DPB, even though there is no need of those reference pictures for decoding the trailing picture and subsequent pictures.

More specifically, in a conventional method during base view decoding, picture marking commands are executed for only the base view. In the proposed method, when a trailing picture of the base view is detected, one or more reference pictures are marked as unused for reference in the base view and also in all the non-base views. As the MVC decoder supports a maximum of 1024 views, when one or more reference pictures are marked as unused for reference in the base view and the one or more non-base views are released from the DPB, the buffer size is significantly reduced. As a result more efficient management of the DPB is obtained.

The proposed method may also release collocated motion vector (MV) buffers associated with one or more reference pictures. The reference pictures contain Y, U, V components and collocated MV buffers. The collocated MV buffers may have one-fourth of the size of the reference pictures. Therefore, the method may release one or more pictures along with the associated collocated MV buffers.

Thus, efficient usage of memory resources in the DPB and earlier post-processing of one or more pictures that are marked as unused for reference may be obtained.

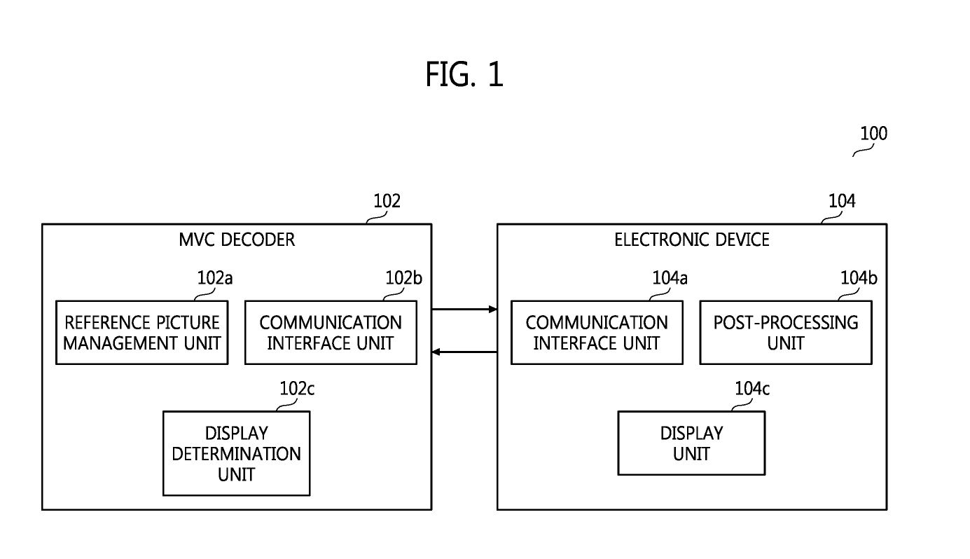

FIG. 1 illustrates a block diagram of a system 100 for managing a Decoded Picture Buffer (DPB) in a Multi-View video Coding (MVC) decoder, according to an exemplary embodiment.

As depicted in the FIG. 1, the system 100 includes an MVC decoder 102 and an electronic device 104. The MVC decoder 102 includes a reference picture management unit 102a, a communication interface unit 102b, and a display determination unit 102c. The reference picture management unit 102a and the display determination unit 102c may be implemented through hardware, software, or a combination of hardware and software. The reference picture management unit 102a and the display determination unit 102c may be implemented through a processor executing instructions stored in memory to effect video coding. The communication interface unit 102b may be a hardware communication interface executing communication software configured to (wired or wirelessly) communicate with the communication interface unit 104a of the electronic device 104 according to one or more communication standards or protocols (e.g., Ethernet, WiFi, Bluetooth, etc.).

The electronic device 104 includes may be a smart phone, laptop, desktop computer, mobile phone, Personal Digital Assistants (PDAs), a tablet, a phablet, a mobile terminal. The electronic device 104 includes a communication interface unit 104a, a post-processing unit 104b, and a display unit 104c.

The communication interface unit 104a may also be a hardware communication interface executing communication software configured to (wired or wirelessly) communicate with the communication interface unit 102b of the MVC Decoder 102 according to one or more communication standards or protocols (e.g., Ethernet, WiFi, Bluetooth, etc.). The post-processing unit 104b may be implemented through hardware, software, or a combination of hardware and software. The post-processing unit 104b may be implemented through a processor executing instructions stored in memory to effect video coding. The display unit 104c may be a display, screen, or other video output mechanism, thereby visually providing decoded video output to a user or viewer of the electronic device 104.

The reference picture management unit 102a may manage one or more reference pictures and one or more non-reference pictures. The one or more reference pictures may be stored in the decoded picture buffer (DPB) and the one or more reference pictures may be used as a reference picture for decoding pictures in the GOP.

The DPB stores the one or more reference pictures and one or more non-reference pictures, when the one or more reference pictures and one or more non-reference pictures are yet to be displayed based on the POC value associated with the one or more reference pictures and the one or more non-reference pictures.

The reference picture management unit 102a may be configured to parse a slice header of the picture for decoding the picture.

The reference picture management unit 102a may be configured to detect the type of the picture in the GOP.

The reference picture management unit 102a may be configured to detect the anchor picture, the leading picture and the trailing picture in the GOP.

The reference picture management unit 102a may be configured to detect the trailing picture after the anchor picture.

If the trailing picture is detected after the anchor picture, the reference picture management unit 102a may be configured to mark the one or more reference pictures prior to the anchor picture as unused for reference.

The communication interface unit 102b may be configured to transmit the one or more pictures marked as unused for reference indicating whether post processing can be initiated by the electronic device 100 through the communication interface unit 104a in the electronic device 104.

The post-processing unit 104b may be configured to perform post-processing on the one or more pictures. Examples of the post-processing include Out of loop Deblocking, Deringing, De-interlacing, and the like.

The display determination unit 102c may be configured to determine whether the one or more pictures are available for display. The pictures may be either reference pictures or non-reference pictures.

The display determination unit 102c may be configured to determine that the one or more pictures are available for display based on the POC values.

If the display determination unit 102c determines that the one or more pictures are available for display, the communication interface unit 102b may be configured transmit the one or more pictures to the electronic device 104 for display.

The display unit 104c may be configured to display one or more pictures.

The communication interface unit 104a may be configured to transmit a message indicating a status of the display of one or more pictures from the electronic device 104 to the communication interface unit 102b in the MVC decoder 102. If the status indicates that one or more pictures are displayed, then the reference picture management unit 102a may be configured to release, from the DPB, one or more pictures that are marked as unused for reference.

The reference picture management unit 102a may be configured to release, from the DPB, collocated MV buffers associated with the one or more pictures that are marked as unused for reference pictures, which are displayed by the electronic device 100 marking at least one reference picture prior to an anchor picture as unused for reference in the base view and at least one non-base view by the reference picture management unit. The pictures contain Y, U, V components and collocated MV buffers. The reference picture management unit 102a may be configured to release the one or more pictures, which are marked as unused for reference by MVC decoder and are displayed by the electronic device 102, along with associated collocated MV buffers.

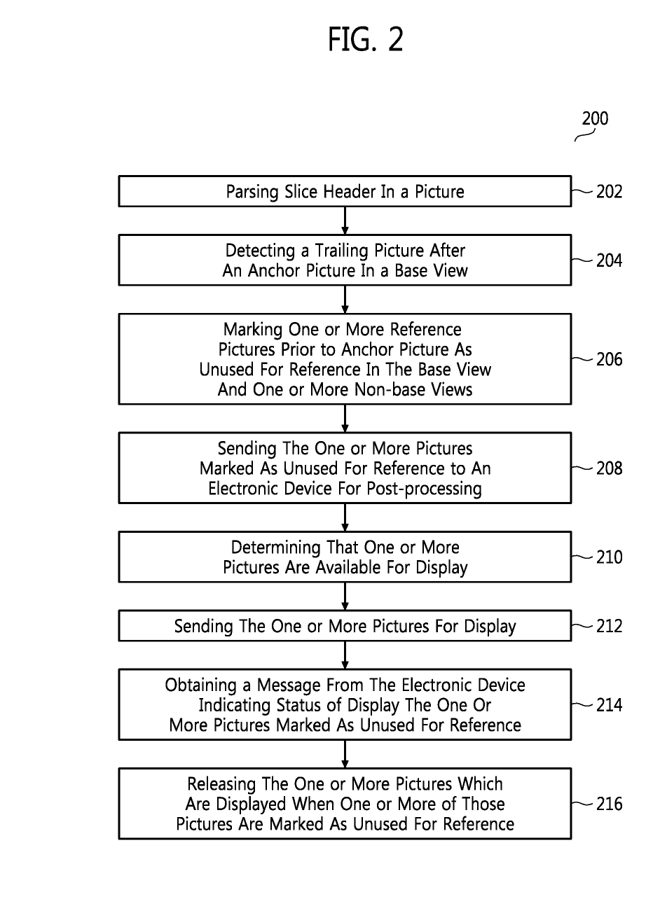

FIG. 2 illustrates a flow chart of a method for managing DPB in the MVC decoder, according to an exemplary embodiment.

The method 200 may be implemented as a control program, which may be executed using a microcontroller or microprocessor reading instructions from a computer readable storage medium.

At step 202, slice header in a picture may be parsed. The reference picture management unit 102a may parse the slice header in the picture. When the slice header of the picture is parsed, picture marking commands are obtained. The picture marking commands are stored for marking the reference pictures in the DPB. The marking of the reference pictures may be performed based on the picture marking commands obtained after parsing the slice header in the picture. Picture marking may be performed according to sliding window marking or through a memory management control operation (MMCO).

At step 204, the trailing picture after the anchor picture in the base view may be detected. The reference picture management unit 102a may detect the trailing picture after the anchor picture in the base view.

At step 206, the one or more reference pictures prior to the anchor picture may be marked as unused for reference in the base view and the all the non-base views. The reference picture management unit 102a may mark the one or more reference pictures prior to the anchor picture as unused for reference in the base view and all the non-base views.

At step 208, the one or more pictures that are marked as unused for reference may be transmitted to the electronic device 104 for post-processing. The communication interface unit 102b may transmit the one or more pictures that are marked as unused for reference to the electronic device 104 for post-processing.

At step 210, it may be determined that one or more pictures are available for display. The display determination unit 102c may determine that the one or more pictures are available for display. The one or more pictures may include either reference pictures or non-reference pictures.

If the display determination unit 102c determines that the one or more pictures are available for display then at step 212, the one or more pictures may be transmitted for display. The communication interface unit 102b may transmit the one or more pictures for display.

At step 214, the message indicating the status of display of one or more pictures may be obtained from the electronic device 104. The communication interface unit 102b may obtain the message indicating the status of display the one or more pictures from the electronic device 104.

If the status indicates that the one or more pictures marked as unused for reference are displayed, then at step 216, those pictures may be released from the DPB. The reference picture management unit 102a may release the one or more pictures from the DPB displayed when one or more of those pictures are marked as unused for reference.

The various actions, acts, blocks, steps, and the like in the method 200 may be performed in the order presented, in a different order or simultaneously. Further, in some embodiments, some actions, acts, blocks, steps, and the like may be omitted, added, modified, skipped, and the like without departing from scope of the invention.

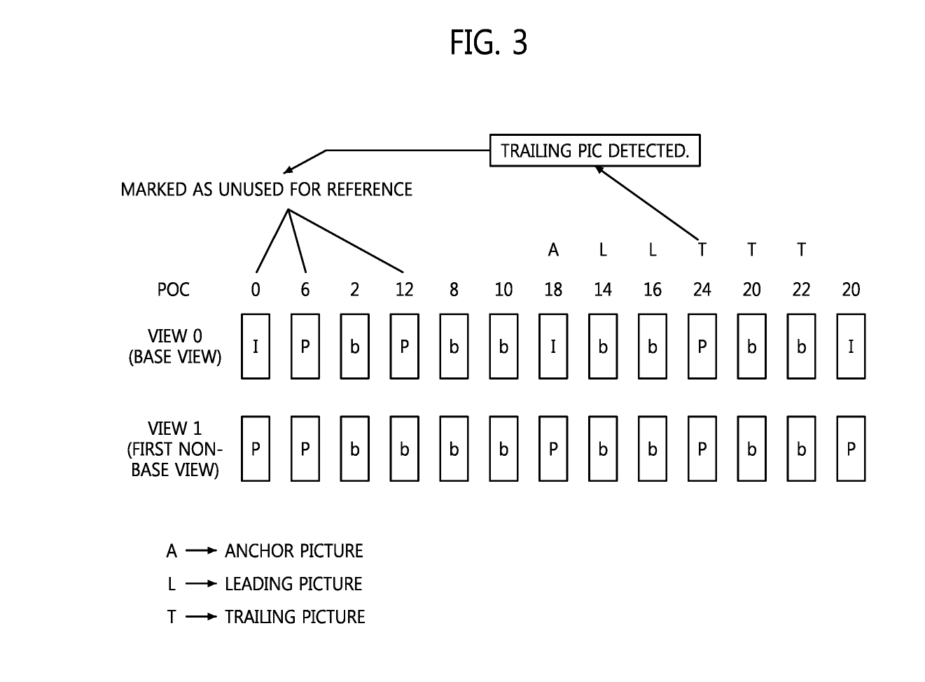

FIG. 3 illustrates a diagram of an example in which the reference pictures prior to the anchor picture are marked in the DPB, according to an exemplary embodiment.

As depicted in the FIG. 3, the pictures with POC values 0, 6 and 12 are considered as the reference pictures and the pictures with POC values 2, 8 and 10 are considered as non-reference pictures. The picture with POC value 18 is considered as the anchor (A) picture. After decoding the anchor picture, if a first trailing (T) picture is detected by the reference picture management unit 102a (at POC 24), then the reference picture management unit 102a may be configured to mark the reference pictures with the POC values 0, 6 and 12, which are prior to the anchor picture as shown in the FIG. 3, as unused for reference. The reference pictures prior to the anchor picture are marked as unused for reference in the base view (view 0) and the non-base view (view 1). Even though FIG. 3 shows only two views, the reference picture management unit 102a may be configured to mark the reference pictures prior to the anchor picture in the base view and all the other non-base views. This is because the MVC decoder supports 1024 views. When the reference pictures are marked as unused for reference, the communication interface unit 102b may be configured to transmit such marked pictures for post-processing.

Further, the display determination unit 102c may be configured to determine that pictures are available for display. The one or more pictures may include either reference pictures or non-reference pictures. If the display determination unit 102c determines that the pictures marked as unused for reference are available for display, then the communication interface unit 102b may be configured to transmit those pictures for display.

The communication interface unit 102b may be configured to obtain the message indicating the status of display of the pictures. If the status indicates that the pictures marked as unused for reference are displayed, then the reference picture management unit 102a may be configured to release those pictures from the DPB in both the base view and in the one or more non-base views. Further, the reference pictures contain Y, U, V components and collocated MV buffers.

In the FIG. 3, for decoding the leading (L) picture (b, with POC as 14), the reference picture ‘P’ with POC 12 is needed. In order to decode the leading picture (with POC 14), the Y, U and V components along with the collocated MV buffers of the reference picture ‘P’ with POC 12 are used. The collocated MV buffers may have one-fourth of the size of the reference picture ‘P’. Hence, the reference picture management unit 102a may be configured to release the marked reference pictures along with the collocated MV buffers for efficient management of the DPB 102.

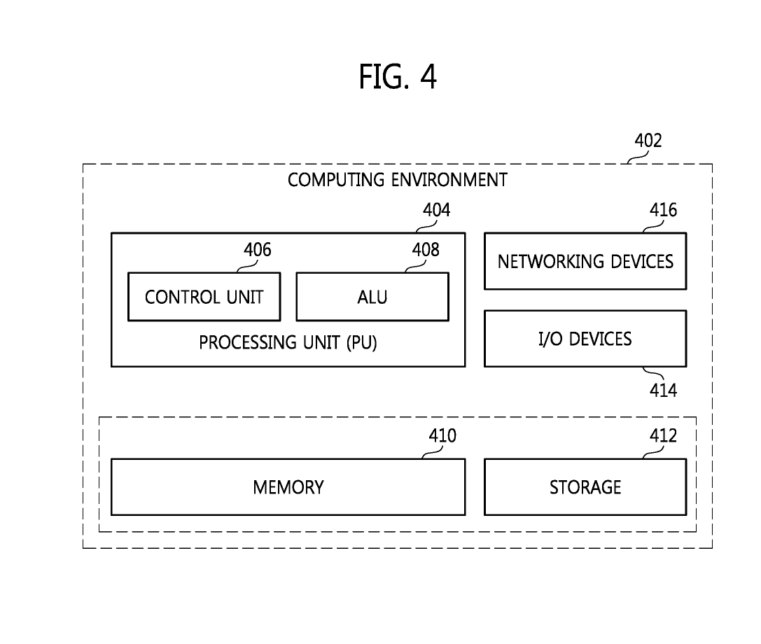

FIG. 4 illustrates a computing environment implementing a method for managing the DPB in the MVC decoder, according to an exemplary embodiment.

As depicted in FIG. 4, the computing environment 402 includes at least one processing unit 404 having a control unit 406 and an Arithmetic Logic Unit (ALU) 408, a memory 410, a storage 412, networking devices 416, and input/output (I/O) devices 414. The processing unit 404 is responsible for executing computer-readable instructions for executing the coding algorithm. The processing unit 404 receives commands from the control unit 406 to perform processing. Further, any logical and arithmetic operations involved in the execution of the instructions are computed with the help of the ALU 408.

The overall computing environment 402 may be composed of multiple homogeneous and/or heterogeneous cores, multiple CPUs of different kinds, special media and other accelerators. The processing unit 404 may be located on a single chip or disposed over multiple chips or processing cores.

The algorithm comprising computer-readable instructions and/or codes may be stored in either the memory 410 or the storage 412, or both. During execution, instructions may be fetched from the corresponding memory 410 and/or storage 412, for example by loading instructions from storage 412 into memory 410, and executed by the processing unit 404.

In case of any hardware implementations, various networking devices 416 or external I/O devices 414 may be connected to the computing environment 402 to support the implementation through one or more communication interfaces.

The exemplary embodiments described herein may be implemented through at least one software program running on at least one hardware device and performing network management functions to control the elements. The elements shown in FIGS. 1 and 4 include blocks of at least one of a hardware device, or a combination of hardware device and software module.

The foregoing description of the exemplary embodiments will so fully reveal the general nature of the present disclosure that persons having ordinary skill in the video coding art can, by applying current knowledge, readily modify and/or adapt for various applications such exemplary embodiments without departing from the generic concept, and, therefore, such adaptations and modifications should and are intended to be comprehended within the meaning and range of equivalents of the exemplary embodiments. It is to be understood that the phraseology or terminology employed herein is for the purpose of description and not of limitation. Therefore, while the exemplary embodiments herein have been described, those skilled in the art will recognize that the exemplary embodiments herein can be practiced with modification within the spirit and scope of the embodiments as described herein.

1. A method of managing a decoded picture buffer (DPB) in a multi-view video coding (MVC) decoder, the method comprising:
receiving a picture sequence, the picture sequence comprising an anchor picture in a base view and a trailing picture temporally after the anchor picture in the picture sequence;
detecting the trailing picture after the anchor picture in the picture sequence; and
marking at least one reference picture prior to the anchor picture in the picture sequence, the at least one reference picture stored in the DPB, as unused for reference in the base view and at least one non-base view.

2. The method of claim 1, further comprising:
transmitting the at least one reference picture marked as unused for reference in the base view and the at least one non-base view to an electronic device.

3. The method of claim 1, further comprising:
receiving a status from the electronic device that indicates the at least one reference picture is displayed; and
releasing the at least one reference picture marked as unused for reference from the DPB, in response to receiving the status.

4. The method of claim 3, further comprising:
releasing a collocated motion vector buffer associated with the at least one reference picture marked as unused for reference from the DPB, in response to receiving the status.

5. A multi-view video coding (MVC) decoder for managing a decoded picture buffer (DPB), the MVC decoder comprising:
at least one processor configured to receive a picture sequence, the picture sequence comprising an anchor picture in a base view and a trailing picture temporally after the anchor picture in the picture sequence, detect the trailing picture after the anchor picture in the picture sequence, and mark at least one reference picture prior to the anchor picture in the picture sequence, the at least one reference picture stored in the DPB, as unused for reference in the base view and at least one non-base view.

6. The MVC decoder of claim 5, further comprising:
a communication interface configured to transmit the at least one reference picture marked as unused for reference in the base view and the at least one non-base view to an electronic device.

7. The MVC decoder of claim 5, wherein the communication interface is further configured to receive a status from the electronic device that indicates the at least one reference picture is displayed, and
wherein the at least one processor is further configured to release the at least one reference picture marked as unused for reference from the DPB, in response to the communication interface receiving the status.

8. The MVC decoder of claim 7, wherein the at least one processor is further configured to release a collocated motion vector buffer associated with the at least one reference picture marked as unused for reference from the DPB, in response to the communication interface receiving the status.

9. A system for managing a decoded picture buffer (DPB) of a multi-view video coding (MVC) picture sequence, the system comprising:
an electronic device; and
an MVC decoder configured to receive the MVC picture sequence, the picture sequence comprising an anchor picture in a base view and a trailing picture temporally after the anchor picture in the picture sequence, detect the trailing picture after the anchor picture the picture sequence, and mark at least one reference picture prior to the anchor picture as unused for reference in the base view, the at least one reference picture stored in the DPB.

10. The system of claim 9, wherein the MVC decoder is further configured to transmit the at least one reference picture marked as unused for reference in the base view and the at least one non-base view to the electronic device.

11. The system of claim 9, wherein the MVC decoder is further configured to receive a status from the electronic device that indicates the at least one reference picture is displayed and release the at least one reference picture marked as unused for reference from the DPB, in response to receiving the status from the electronic device.

12. The system of claim 11, wherein the MVC decoder is further configured to release a collocated motion vector buffer associated with the at least one reference picture marked as unused for reference from the DPB, in response to receiving the status from the electronic device.

13. A non-transitory computer-readable recording medium having embodied thereon a computer executable program, said computer executable program when executed causing a multi-view video coding (MVC) decoder to execute a method of managing a decoded picture buffer (DPB, the method comprising:
receiving a picture sequence, the picture sequence comprising an anchor picture in a base view and a trailing picture temporally after the anchor picture in the picture sequence;
detecting the trailing picture after the anchor picture in the picture sequence; and
marking at least one reference picture prior to the anchor picture in the picture sequence, the at least one reference picture stored in the DPB, as unused for reference in the base view and at least one non-base view.
